(19) United States
(12) Patent Application Publication
(10) Pub. No.: US 2014/0025206 A1
(43) Pub. Date: Jan. 23, 2014

(54) DRUG MIXING PREPARATION MANAGING APPARATUS, DRUG MIXING PREPARATION MANAGING SYSTEM AND CONTROL PROGRAM

(71) Applicant: Toshiba Tec Kabushiki Kaisha, Tokyo (JP)

(72) Inventors: Shiomi MATSUI, Shizuoka (JP); Yasutsugu SASAKI, Tokyo (JP); Maki Sato, Kanagawa (JP)

(21) Appl. No.: 13/943,577

(22) Filed: Jul. 16, 2013

(30) Foreign Application Priority Data
Jul. 17, 2012 (JP) 2012-159100

(51) Int. Cl. G05D 11/13

(52) U.S. Cl. CPC G05D 11/13
USPC 700/265

(57) ABSTRACT

A method of managing a drug mixing preparation process includes obtaining a mixed injection preparation instruction (e.g., a prescription) and displaying a screen for an operator (e.g., a nurse) to make changes to the preparation instruction. When a change is made by the operator, a connection is made to an information processing terminal (e.g., a remote computer terminal, a smart phone, or tablet device) though a network and, a user (e.g., a doctor) of the information processing terminal is requested to approve the change to the preparation instruction entered by the operator. If the change is approved, a mixed injection preparation process is managed accordance with the changed preparation instructions.

### CROSS-REFERENCE TO RELATED APPLICATION

This application is based upon and claims the benefit of priority from Japanese Patent Application No. 2012-159100, filed Jul. 17, 2012, the entire contents of which are incorporated herein by reference.

### FIELD

Exemplary embodiments described herein relate to a drug mixing preparation managing apparatus, a drug mixing preparation managing system, and a control program.

### BACKGROUND

In the related art, in a pharmacy of a hospital, a nurse room of a hospital ward, or the like, a pharmacist or a nurse performs a preparation work (hereinafter, mixed injection preparation) of drugs on the basis of an instruction such as a prescription or an injection prescription generated by a doctor, or the like.

When the mixed injection preparation is performed, the pharmacist or the nurse sorts drugs that are to be included in the mixed injection preparation (the prescribed drugs) with reference to the instruction, and performs measurement, dissolution, mixing and the like in an appropriate order with respect to the prescribed drugs.

In order to reliably perform the mixed injection preparation, the pharmacist or nurse performs an inspection process of checking whether the drugs to be included (candidate drugs) are actually the prescribed drugs by cross-referencing labels of the drugs and the instruction, before the mixed injection is prepared or administered.

However, there are several reasons why the inspection of drugs may be performed erroneously. Specifically, various human errors such as a misreading of a similar medicine name or a failure to confirm an expiration date before use. Even though the above-mentioned inspection work is performed, it is not easy to prevent all possible erroneous mixed injection preparations.

Thus, in the related art, several systems that support a preparation inspection to reliably prevent the occurrence of prescription errors have been proposed.

For example, JP-A-2005-334056 discloses a preparation support system in which in a portable terminal, prescribed drugs indicated by a bar code read from a bar code form and the amounts thereof are stored in a data storage unit and are displayed on a display unit, and whenever a bar code displayed on each container of medicine to be included for each prescription for each patient is read, it may be checked whether the medicine is a prescribed drug on the basis of medicine information indicated by the bar code and information about the prescribed drugs stored in the data storage unit.

However, in the related art, a necessary drug and a necessary amount are only displayed as a list in a text form on a screen displayed before inspection, and it is difficult to make an inquiry about content thereof to a doctor, or the like, who has set the content of the mixed injection instruction.

### DESCRIPTION OF THE DRAWINGS

FIG. 1 is a block diagram illustrating a schematic configuration of a drug mixing preparation managing system.

FIG. 2 is a front view illustrating a mixed injection terminal according to an embodiment.

FIG. 3 is a block diagram illustrating a schematic configuration of a mixed injection terminal.

FIG. 4 is a process flowchart of a mixed injection terminal according to an embodiment.

FIG. 5 is a diagram illustrating an example of a login instruction screen.

FIG. 6 is a diagram illustrating an example of an order number input screen.

FIG. 7 is a diagram illustrating an example of an order content display screen.

FIG. 8 is a flowchart of a doctor inquiry process.

FIG. 9 is a diagram illustrating an example of an inquiry confirmation screen.

FIG. 10 is a diagram illustrating an example of an instruction content change screen.

FIG. 11 is a diagram illustrating an example of an order content change screen.

FIG. 12 is a diagram illustrating display screen transition.

FIG. 13 is a diagram illustrating an example of an order number input screen during a doctor inquiry process.

FIG. 14 is a flowchart of a drug inspection process.

FIG. 15 is a diagram illustrating an example of an inspection completion screen.

FIG. 16 is a diagram illustrating an example of a display screen of an inspection result.

FIG. 17 is a diagram illustrating an example of a display screen of an inspection result when all drugs are inspected.

FIG. 18 is a diagram illustrating an example of an expiration notification screen.

FIG. 19 is a diagram illustrating an example of an excessive amount notification screen.

FIG. 20 is a diagram illustrating an example of a mistaken drug preparation notification screen.

FIG. 21 is a diagram illustrating an example of an execution information confirmation instruction screen.

FIG. 22 is a diagram illustrating an example of a medical record confirmation instruction screen.

FIG. 23 is a diagram illustrating an example of a re-sorting confirmation screen.

FIG. 24 is a diagram illustrating a display example of an order content display screen when re-sorting is desired.

FIG. 25 is a flowchart of a button tapping process performed as an interruption process.

FIG. 26 is a diagram illustrating an example of a stop confirmation screen.

FIG. 27 is a diagram illustrating an example of a logout confirmation screen.

FIG. 28 is a diagram illustrating an example of a comment screen.

FIG. 29 is a diagram illustrating an example of a detailed drug information confirmation screen.

FIG. 30 is a diagram illustrating an example of an initial screen of a temporary order input process.

### DETAILED DESCRIPTION

According to an embodiment, a method of managing a drug mixing preparation process includes obtaining a mixed injection preparation instruction (e.g., a prescription) and displaying a screen for an operator (e.g., a nurse) to make changes to the preparation instruction. When a change is made by the operator, a connection is made to an information processing terminal (e.g., a remote computer terminal, a smart phone, or tablet device) though a network and, a user (e.g., a doctor) of the information processing terminal is requested to approve the change to the preparation instruction entered by the operator. If the change is approved, a mixed injection preparation process is managed accordance with the changed preparation instructions.

According to another embodiment of the present disclosure, there is provided a drug mixing preparation managing apparatus including a communication interface for receiving a mixed injection preparation instruction and for connecting to an information processing terminal (e.g., a remote computer, a smart phone, a tablet device, or the like) through a network (e.g., a local area network, the Internet, a public communications network, or the like). The apparatus further includes a display module configured to display the content of the mixed injection preparation instruction and to display a change screen allowing an operator (e.g., a nurse, pharmacist, or the like) to make changes to the mixed injection preparation instruction. Also included is an inquiry module which inquires through the network as to whether a user (e.g., a doctor or the like) of the information processing terminal approves the change to the mixed injection preparation instruction. The apparatus additionally includes an inspection processing module for managing a mixed injection preparation process in accordance with a changed preparation instruction after the user of the information processing terminal approves the change to the preparation instruction.

Next, exemplary embodiments will be described referring to the accompanying drawings.

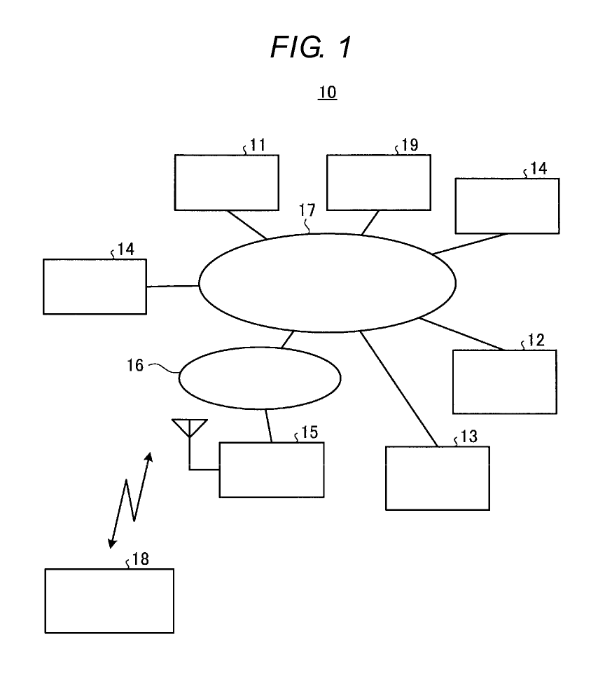

FIG. 1 is a block diagram illustrating a schematic configuration of a drug mixing preparation managing system.

A drug mixing preparation managing system 10 includes an electronic medical record server 11 that manages and stores an electronic medical record, an information processing terminal 12 for a doctor (or the like) to use in generating or editing of an electronic medical record or the like, an information processing terminal 13 for a nurse (or the like) for performing reference and confirmation of the electronic medical record managed by the electronic medical record server 11, mixed injection terminals 14 that perform a mixed injection preparation support such as aiding drug sorting on the basis of instruction information (for example, prescription information) included in the electronic medical record, a mobile information processing terminal 18 that is connected to a communication network 17 through a wireless base station 15 and a public communication network 16 with which a doctor (or the like) can review, generate, edit, or the like, the electronic medical record, and a pharmacy server 19 that is disposed in a pharmacy and manages drug payment, invoicing, or the like.

In the above example configuration, the electronic medical record server 11, the information processing terminal 12, the information processing terminal 13, the mixed injection terminal 14 and the pharmacy server 19 are connected to the communication network 17.

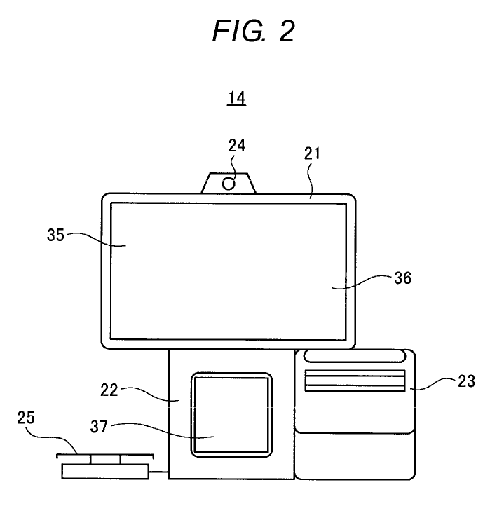

FIG. 2 is a front view depicting the appearance of a mixed injection terminal 14.

The mixed injection terminal 14 includes a touch panel display 21 through which a user performs various operations. The touch panel display 21 is capable of displaying various information such as a list of drugs to be included in the mixed injection or an inspection state of these drugs. The mixed injection terminal 14 in this embodiment includes a device body 22 that has a scanner 37 configured as an object scanner that can scan an ID of a user (e.g. a nurse), a bar code of a drug container, an image of the drug or drug container and the like, a printer 23 for printing out information, a camera 24 that images a work state of an operator, and a scale 25 that measures the weight of a drug that is a candidate for inclusion in a mixed injection preparation.

Though in this example embodiment scanner 37 is a fixed-type scanner that is integrated with or mounted to the device body 22, in other embodiments scanner 37 may be a hand-type scanner that is separable or separate from the device body 22. In such a case, the hand-type scanner may be connected by a wire or cord to the device body 22 and/or may be in wireless communication with the other components of the mixed injection terminal 14.

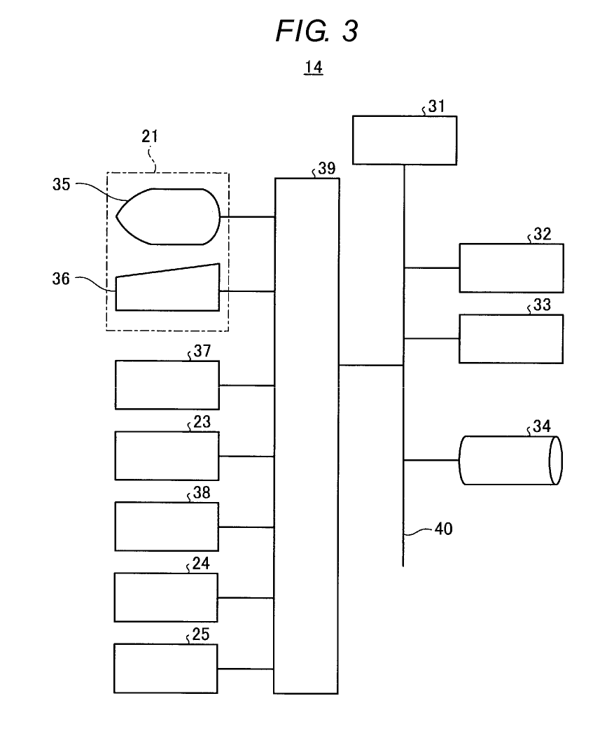

FIG. 3 is a block diagram illustrating a schematic configuration of the mixed injection terminal 14.

The mixed injection terminal 14 includes an MPU 31 that controls the overall operation of the mixed injection terminal, a ROM 32 that stores various data that includes a control program in a non-volatile manner, a RAM 33 that functions as a work area and temporarily stores various data, an external storage unit 34 configured as a hard disk drive or a solid state drive (SSD) capable of storing a large amount of data such as a database, a display 35 and a touch panel 36 that collectively form the touch panel display 21, the scanner 37, the printer 23, and a communication interface 38.

Here, in this embodiment, the touch panel display 21, the scanner 37, the printer 23 and the communication interface 38 are connected to a bus 40 through an input and output module I/O 39.

Further, in the external storage unit 34, images (including moving images, such as video) captured by the camera 24 from login to logout are stored as a work record, and weights of a drug before and after a mixed injection work measured by the scale 25 and data on a difference thereof are stored as a work record.

The MPU 31, the ROM 32, the RAM 33, and the external storage unit 34, in addition to the communication interface 38, are connected to the bus 40.

Next, an operation of the exemplary embodiment will be described.

Before the mixed injection is administered, a doctor creates an electronic medical record that includes drug instruction data (for example, prescription data) using the information processing terminal 12 and registers the electronic medical record in the electronic medical record server 11.

In this case, information for specifying drugs that are to be included in the mixed injection preparation and information relating to the amount (e.g., dosage level, volume, or weight) of each necessary drug are included in the instruction data, and an order number for specifying the instruction data is allocated thereto. An order number is sent together with each mixed injection preparation instruction (also referred to as a mixed injection instruction) to a pharmacist or a nurse who sorts the drugs to be included in the prescribed mixed injection, or the order number is printed as a symbol code such as a bar code on the instruction.

On the other hand, if an operator such as a nurse who actually sorts the drugs receives the order number, the operator performs a preparation work for the mixed injection.

Here, a preparation process of a mixed injection target (i.e., a prescribed mixed injection) will be described.

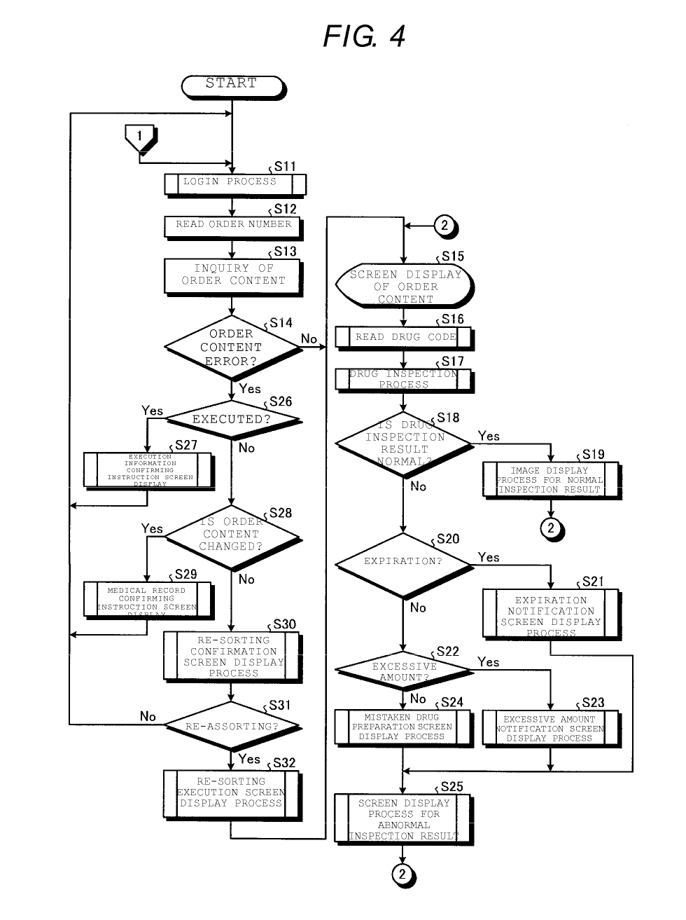

FIG. 4 is a processing flowchart of a mixed injection terminal according to an exemplary embodiment.

In the following description, each operator who is allowed to operate the mixed injection terminal 14 has an ID card and the operator is able to operate the mixed injection terminal 14 only by authentication of the ID card using, for example, scanner 37.

On the display 35 of the touch panel display 21 of the mixed injection terminal 14, a login screen is displayed as an initial state.

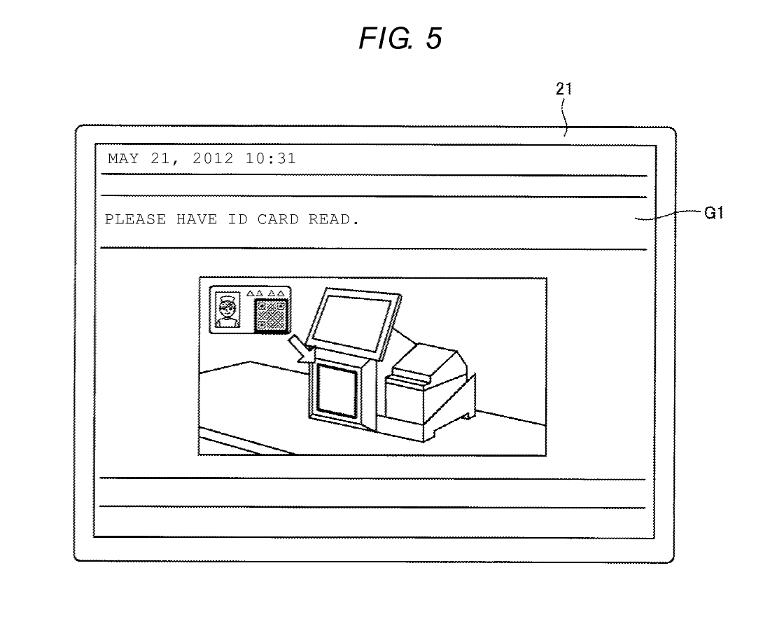

FIG. 5 is a diagram illustrating an example of a login screen.

As shown in FIG. 5, a guide comment “Please have ID card read” and a guide image that prompts the scanner 37 to read the ID card are displayed on a login screen G1.

Accordingly, in order to perform the login process, an operator places his/her ID card in front of the scanner 37 to cause the scanner 37 to read an ID code (step S11).

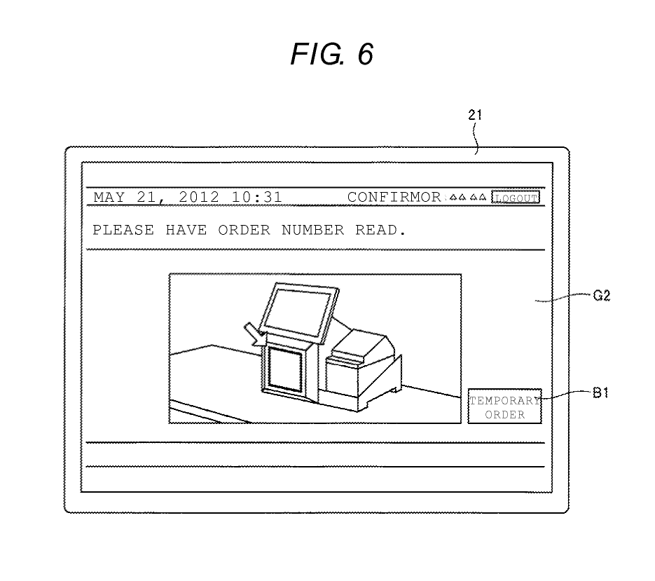

FIG. 6 is a diagram illustrating an example of an order number input screen.

If the ID code is authenticated by the login process, the MPU 31 of the mixed injection terminal 14 displays an order number input screen G2 on a display screen of the display 35 in order to prompt reading of an order number for specifying the content mixed injection preparation (step S12).

As shown in FIG. 6, a guide comment “Please have order number read” and a guide image that prompts the operator to use scanner 37 to read the order number are displayed on the order number input screen G2. Further, when the guide image is displayed, a temporary order button B1 that allows a mixed injection to be prepared without an allocated order number is displayed.

Thus, if the operator causes the order number to be read by the scanner 37, the MPU 31 of the mixed injection terminal 14 makes an inquiry about the content corresponding to the order number to the electronic medical record server 11 or the pharmacy server 19 through the communication interface 38 and the communication network 17 (step S13).

Subsequently, the MPU 31 of the mixed injection terminal 14 determines whether an error occurs in the retrieval of order content on the basis of information supplied in the response of the electronic medical record server 11 or the pharmacy server 19 with respect to the inquiry of the mixed injection content (e.g., the prescription) (step S14).

In the determination of step S14, if the response of the electronic medical record server 11 or the pharmacy server 19 is a transmission of list data on the drugs to be included in the mixed injection preparation corresponding to the order number, this means that there is no error in the order content (No in step S14), and thus, the MPU 31 displays an order content display screen G3 on the basis of the obtained list of drugs to be included in the mixed injection preparation (step S15).

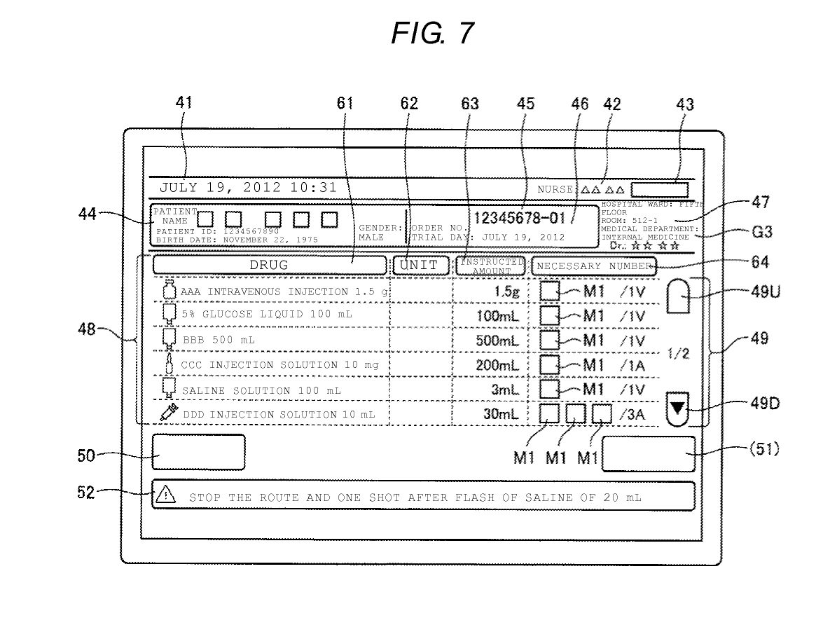

FIG. 7 is a diagram illustrating a display example of an order content display screen.

The order content display screen G3 includes a date information display area 41, an operator name display area 42, a logout button 43, a patient information display area 44, an order number display area 45, a trial day display area 46, a patient related information display area 47, a drug list display area 48, a list down-scroll button display area 49, a stop button 50, a completion button 51, a comment display area 52, and an inquiry button 53.

In the operating state depicted in FIG. 7, the completion button 51 is in a non-operable state, and thus, the reference numeral is written in a parenthesis.

The date information display area 41 is an area where the inspection process date is displayed.

The operator name display area 42 is an area where the name of an operator who inspects the drugs is displayed.

The logout button 43 is a button through which the operator is logged out.

The patient information display area 44 is an area where information for specifying a patient for which the drugs are to be prescribed is displayed. Specifically, name, ID, birth date and gender of the patient are displayed in this example.

The order number display area 45 is an area where an order number obtained in step S12 is displayed.

The trial day display area 46 is an area where a trial day, that is the date when the prescribed drugs are to be administered to the patient, is displayed. The trial day is designated in the electronic medical record.

The patient related information display area 47 is an area where information relating to the patient is displayed. Specifically, ward information, hospital room information, medical care information, and a name of a doctor in charge are displayed in this example.

The drug list display area 48 includes a drug name display area 61 that displays the names of drugs to be included in the mixed injection preparation, a unit number display area 62 where when the amount of drug prescription is designated as a unit (e.g., dosage level), the number of units to be prescribed is displayed, an instructed amount display area 63 where when the amount of drug prescribed is designated as an instructed amount (weight or volume), the amount to be prescribed (weight or volume) is displayed, and a necessary number display area 64 where the unit number of a drug (e.g., the number of ampoules, vials, bags, tablets or the like) necessary for satisfying the unit number designated by the unit number display area 62 or the instructed amount designated by the instruction amount display area 63 is displayed in a line using the same number of marks (e.g., icons, patterns, symbols) M1 as the unit number of the drug and the unit number of the drug is also displayed as a numerical value. In the example in FIG. 7, all the marks M1 are displayed with the same size, but when the unit number of a drug is large, the display may be reduced in size. Further, if the number exceeds a predetermined number (for example, five), the display may be performed in a new line after every predetermined number (for example, every five).

In the example in FIG. 7, for example, as shown in the top part of the list, since a drug name “1.5 g for AAA intravenous injection” (container type: vial) has an instructed amount of 1.5 g, in the necessary number display area 64, one mark M1 that indicates that it is necessary to use one vial is disposed, and “/1V” that indicates that the total number corresponds to one vial is displayed. Further, as shown in the bottom part of the list, since a drug name “DDD injection of 10 mL” (container type: ampoule) has an instructed amount of 30 mL, three marks M1 that indicate that it is necessary to use three ampoules, and “/3A” that indicates that the total number corresponds to 3 ampoules is displayed.

In the list scroll button display area 49, when a list of all drugs cannot be displayed in the drug list display area 48 at a time, an up-scroll button 49U for scrolling the list upward, and a down-scroll button 49D for scrolling the list downward are disposed. In the example in FIG. 7, since it is not possible to scroll the list upward from the beginning of the displayed list, the up-scroll button 49U is represented in a gray-out display state, which represents a non-operable state.

The stop button 50 is a button for instructing stop of the inspection process.

The completion button 51 is a button that is in an operable state when the entire inspection process of the drugs of the mixed injection targets is terminated, and enters a gray-out display state since the inspection process is not terminated in FIG. 7, which represents a non-operable state.

The comment display area 52 is an area where when a comment to be noted in mixed injection of the drugs of the mixed injection targets is registered, the comment is displayed.

The inquiry button 53 is a button tapped when a process of easily making an inquiry about an order content to the doctor who creates the order content when there is a question or a doubt about the order content (hereinafter, referred to as a doctor inquiry process).

Here, a doctor inquiry process according to the exemplary embodiment will be described.

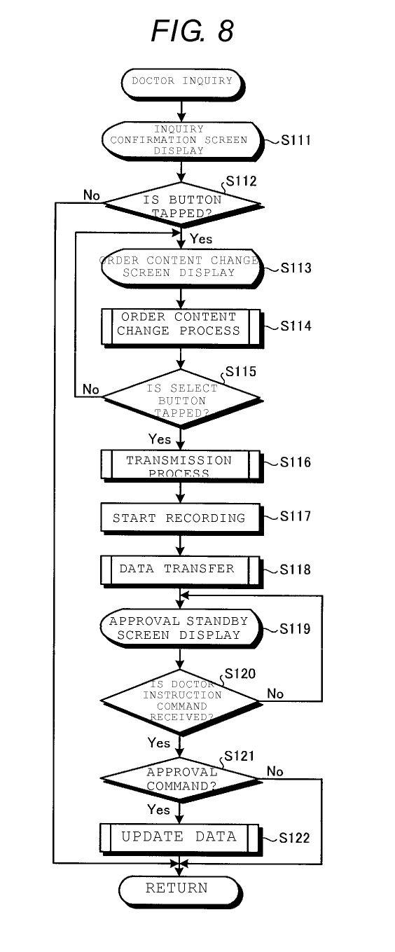

FIG. 8 is a processing flowchart of the doctor inquiry process.

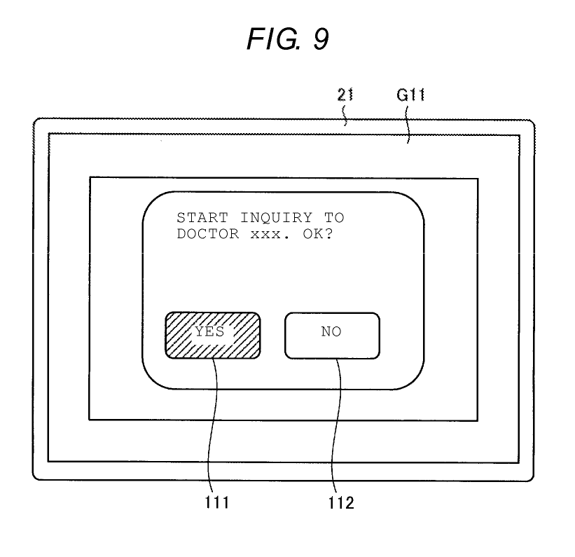

FIG. 9 is a diagram illustrating an example of an inquiry confirmation screen.

If the inquiry button 53 is tapped by an operator when the order content display screen G3 is being displayed, the MPU 31 displays an inquiry confirmation screen G11 shown in FIG. 9 (step S111).

If the name of the doctor who creates the order content is “xxxx”, a message “Start inquiry to Dr. xxxx. OK?” is displayed on the inquiry confirmation screen G11, and a “Yes” button 111 and a “No” button 112 are displayed thereon, as shown in FIG. 9.

Next, the MPU 31 determines whether the “Yes” button 111 or the “No” button 112 is tapped (step S112).

In the determination of step S112, if the “No” button 112 is tapped (No in step S112), the doctor inquiry process is terminated, and the MPU 31 returns again to the order content display screen G3 shown in FIG. 7.

In the determination of step S112, if the “Yes” button 111 is tapped (Yes in step S112), the MPU 31 proceeds to an instruction content change screen display (step S113).

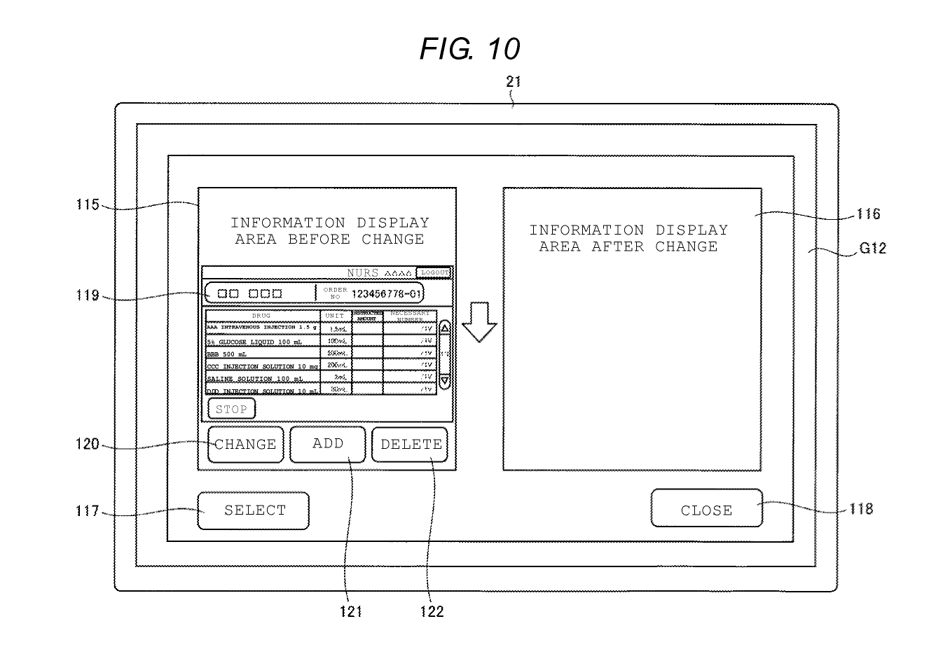

FIG. 10 is a diagram illustrating an example of an instruction content change screen.

An instruction content change screen G12 includes an information display area before change 115, an information display area after change 116, a select button 117, and a close button 118.

The information display area before change 115 includes an order content display area 119, a change button 120, an add button 121, and a delete button 122.

The order content display area 119 is an area where the same content as the order content display screen G3 before change is displayed. Here, an area of the order content display screen G3 corresponding to the drug list display area 48 may be set so that a drug or an instructed amount thereof tapped by tapping a section of a name of a certain drug or an instructed amount thereof is designated as a change target or a delete target.

The change button 120 is a button for proceeding to a process of changing the drug designated by the order content display area 119 or the instructed amount of the drug by tapping.

The add button 121 is a button for proceeding to a process of adding a new drug and an instructed amount thereof into the order content display area 119 by tapping.

The delete button 122 is a button for proceeding to a process of deleting the drug and the instructed amount thereof in the order content display area 119 by tapping.

The information display area after change 116 is an area where the order content after the changes is displayed.

The select button 117 is a button tapped when the order content displayed in the information display area after change 116 is selected as the order content after change.

The close button 118 is a button for returning to the display of the order content display screen G3 by stopping the display of the order content change screen G12.

Subsequently, the MPU 31 performs an order content change process (step S114).

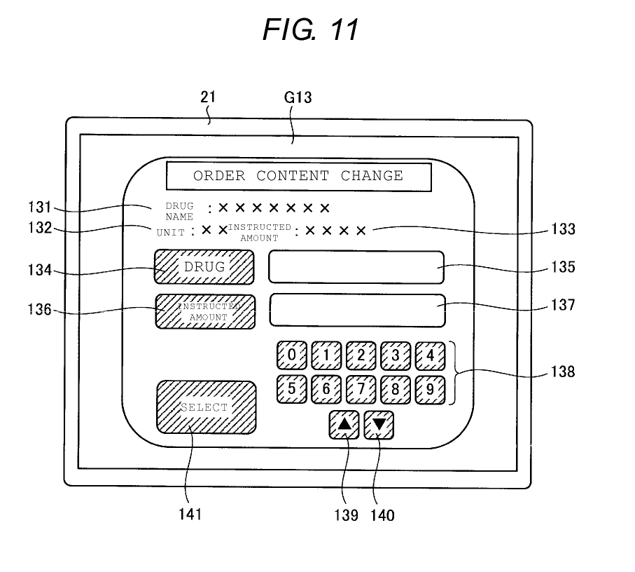

FIG. 11 is a diagram illustrating an example of an order content change screen.

In the order content change process, if the change button 120 or the add button 121 in the order content change screen G12 is tapped, the order content change screen G13 is displayed.

The order content change screen G13 includes a drug name display area 131, a unit display area 132, an instructed amount display area 133, a drug designation button 134, a designated drug display area 135, an instructed amount designation button 136, a designated instructed amount display area 137, an instructed amount designating numerical value button group 138, a fine increase control button 139, a fine decrease control button 140, a select button 141.

In the drug name display area 131, if the change button 120 is tapped, a drug name of a currently selected drug is displayed, and if the add button 121 is tapped, a blank space is displayed.

In the unit display area 132, if the change button 120 is tapped, when the amount of prescription of the currently selected drug is designated as a unit that shows a factor (amount in which a drug shows a specific biological effect), the number of units to be prescribed is displayed, and if the add button 121 is tapped, a blank space is displayed.

In the instructed amount display area 133, when the prescribed amount of the currently selected drug is designated as an instructed amount (weight or volume), the amount to be prescribed (weight or volume) is displayed.

The drug designation button 134 is a button for starting operation of the scanner 37 to enter a state where the scanner 37 is able to read, in this example, a GS1 data bar (GS1-RSS code: medical drug bar code) indicated on a container or a label of a drug that is to be changed or added by an operator.

The designated drug display area 135 is an area where a name of a drug designated when the operator causes the scanner 37 to read the GS1 data bar is displayed.

The instructed amount designation button 136 is a button tapped before setting of the instructed amount of the drug, through which the operator is able to input the instructed amount using (e.g., by tapping) the instructed amount designating numerical value button group 138, the fine increase control button 139, and the fine decrease control button 140.

The designated instructed amount display area 137 is an area where the instructed amount of the drug input by the operator is displayed.

The instructed amount designating numerical value button group 138 is a button group that includes plural numerical value buttons (0 to 9), through which the numerical values are directly input.

The fine increase control button 139 is a button for increasing the instructed amount of the drug designated by the instructed amount designating numerical value button group 138 by a predetermined amount by tapping to perform fine control of the instructed amount of the drug.

The fine decrease control button 140 is a button for decreasing the instructed amount of the drug designated by the instructed amount designating numerical value button group 138 by a predetermined amount by tapping to perform fine control of the instructed amount of the drug.

The select button 141 is a button for fixing the drug displayed in the designated drug display area 135 and the instructed amount displayed in the designated instructed amount display area 137 by tapping and for display the result in the information display area after change 116.

Accordingly, if the select button 141 is tapped in the order content change screen G13 and the drug displayed in the designated drug display area 135 and the instructed amount displayed in the designated instructed amount display area 137 are fixed, the MPU 31 displays again the order content change screen G12, fixes the drug displayed in the designated drug display area 135 and the instructed amount displayed in the designated instructed amount display area 137, and then displays the result in the information display area after change 116.

In this state, it is determined whether the operator taps the select button of the order content change screen G12 (step S115).

In the determination of step S115, if the select button 117 is not tapped (No in step S115), the MPU 31 causes the procedure to proceed to step S113 again, to be able to perform the content change.

On the other hand, in the determination of step S115, if the select button 117 is tapped (Yes in step S115), the MPU 31 performs a transmission process of performing communication (e.g., a telephone call and data communication) with the mobile information processing terminal 18 through the communication network 17, the public communication network 16, such as a telephone line network, and the wireless base station 15 (step S116).

Further, the MPU 31 starts recording for recording a telephone call (step S117), and performs data transfer for displaying the content of the order content change screen G13 at the same time (step S118).

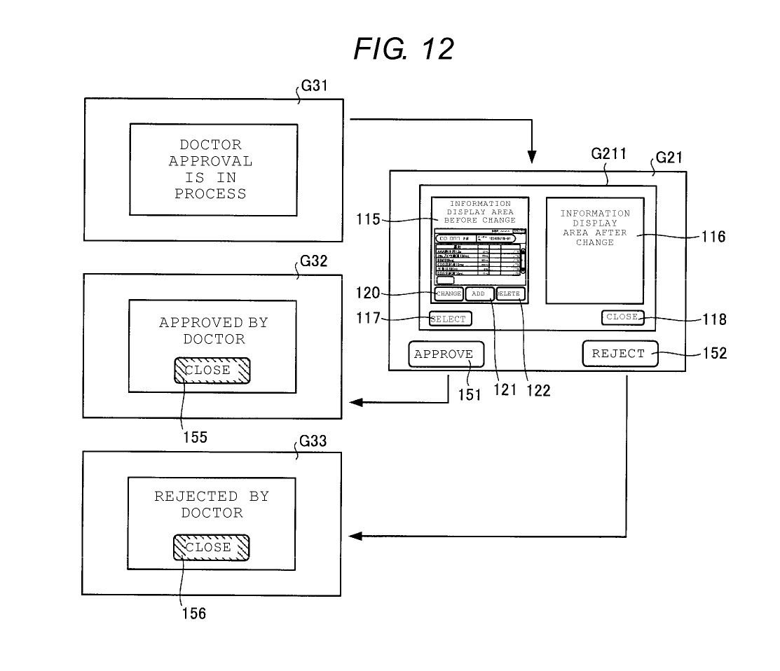

FIG. 12 is a diagram illustrating display screen transition.

Further, in the MPU 31, a doctor approval in-process screen G31 shown in FIG. 12 is displayed on the display screen of the mixed injection terminal 14 during a call/communication with a doctor in charge, during data transfer and during waiting for approval of the doctor after data transfer (step S119).

On the other hand, since an approval processing screen G21 shown in FIG. 12 is displayed on the display screen of the mobile information processing terminal 18, the doctor in charge may make a phone call for receiving additional description from the operator, may change the display content according to the same operation as in the above-mentioned order content change screen G12 in a doctor side order content change screen G211, may perform an approval command transmission operation according to a change content approval operation using an approval button 151, or may perform a reject command transmission operation according to a change content reject operation using a reject button 152.

In addition, the MPU 31 of the mixed injection terminal 14 determines whether an instruction command of the doctor in charge is received from the mobile information processing terminal 18 through the wireless base station 15, the public communication network 16, and the communication network 17 (step S120).

In the determination of step S120, if the instruction command (approval command or reject command) of the doctor in charge is not yet received (No in step S120), the procedure proceeds to step S119 to enter a standby state.

Further, in the determination of step S120, if the instruction command is received (Yes in step S120), the MPU 31 determines whether the received instruction command is an approval command (step S121).

In the determination of step S121, if the received instruction command is the approval command, the MPU 31 of the mixed injection terminal 14 displays an approval screen G32 shown in FIG. 12, and performs updating of the order content into a change content that is an approval target at the same time when the approval screen G32 is displayed or after the “close” button 155 is tapped by the operator to transit again to the display of the order content display screen G3 (step S15).

In this case, on the order content display screen G3, the changed order content is displayed in a display state different from the order content that has not been changed to provide ease of identification of the changed content. For example, as a method of differentiating the display state, reverse display, blinking display, background color changing, text color changing, text font changing or the like may be used.

In the determination of step S121, if the received instruction command is the reject command, the MPU 31 of the mixed injection terminal 14 displays a reject screen G33 shown in FIG. 12, and returns again to the display of the order content display screen G3 without changing the order content after the “close” button 156 is tapped by the operator (step S15).

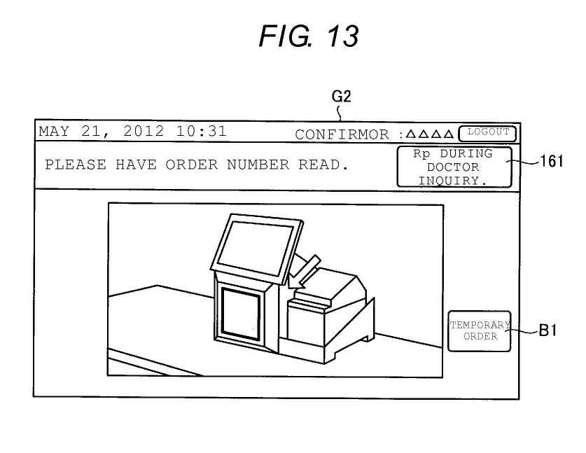

FIG. 13 is a diagram illustrating a display example of an order number input screen while a doctor inquiry process is being performed.

In the middle of the doctor inquiry process, if the order number input screen G2 is displayed, as shown in FIG. 13, an inquiry in-process button 161 is displayed on the order number input screen G2. As the inquiry in-process button 161 is tapped, it is possible to transit to the display of the order content change screen G13, but other operations are not allowed.

Subsequently, in a state where the order content display screen G3 in FIG. 7 is displayed, in order to perform the inspection process of the drugs of the mixed injection targets, the operator causes the scanner 37 to read an GS1 data bar (GS1-RSS code: medical drug bar code) indicated on a container or a label of a drug that is the candidate drug for the mixed injection preparation (step S16).

Thus, the MPU 31 performs the drug inspection process on the basis of the content of the drug list and the GS1 data bar read in step S16 (step S17).

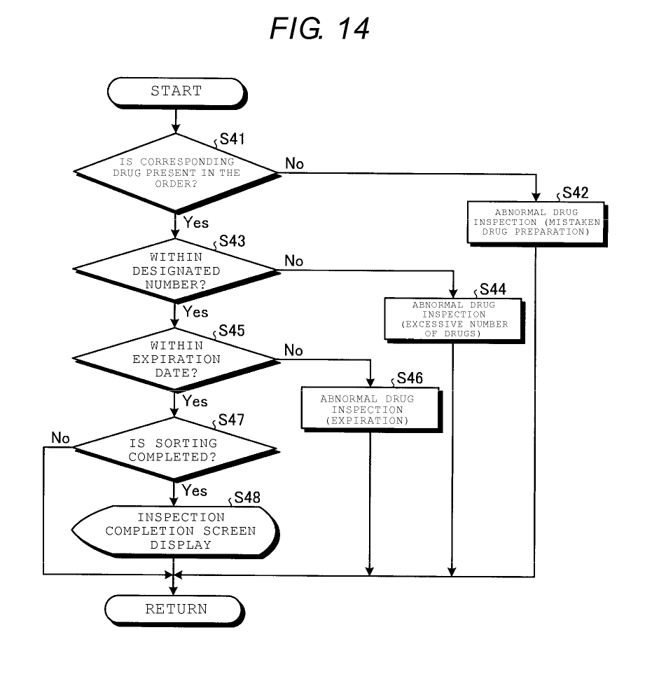

FIG. 14 is a flowchart of the drug inspection process.

First, the MPU 31 determines whether the drug corresponding to the read GS1 data bar is included in the order (mixed injection preparation instruction) (step S41).

In the determination in FIG. 41, if the drug corresponding to the read GS1 data bar is not included in the order (No in step S41), the MPU 31 determines this case as an abnormal drug inspection, or a mistaken preparation, in which a wrong drug that is not to be included in the order has been prepared (step S42), and terminates the drug inspection process. Then, the procedure proceeds to step S18.

In the determination of step S41, if the drug corresponding to the read GS1 data bar is included in the order (Yes in step S41), the MPU 31 determines whether the number (e.g., dosage level) of the drug corresponding to the read GS1 data bar is within a designated number (step S43).

In the determination of step S43, if the number of the drug corresponding to the read GS1 data bar is not within the designated number, that is, if the number of the drug exceeds the designated number (No in step S43), the MPU 31 determines this case as an abnormal drug inspection of an excessive drug number in which the drug of an amount larger than the amount of the drug to be prescribed is prepared (step S44), and terminates the drug inspection process. Then, the procedure proceeds to step S18.

In the determination of step S43, if the number of the drug corresponding to the read GS1 data bar is within the designated number (Yes in step S43), the MPU 31 determines whether the drug corresponding to the read GS1 data bar is within an expiration date (step S45).

In the determination of step S45, if the drug corresponding to the read GS1 data bar is not within the expiration date, that is, if the expiration date of the drug has passed (No in step S45), the MPU 31 determines this case as an abnormal drug inspection in which the drug cannot be used in mixing injection due to expiration (step S46), and terminates the drug inspection process. Then, the procedure proceeds to step S18.

In the determination of step S45, if the drug corresponding to the read GS1 data bar is within the expiration date (Yes in step S45), the MPU 31 determines whether inspection of all the prescribed drugs is completed by the current process (step S47).

In the determination of step S47, if the inspection of all the drugs is completed (Yes in step S47), the MPU 31 displays an inspection completion screen (step S48), and causes the inspection completion procedure to proceed to step S18.

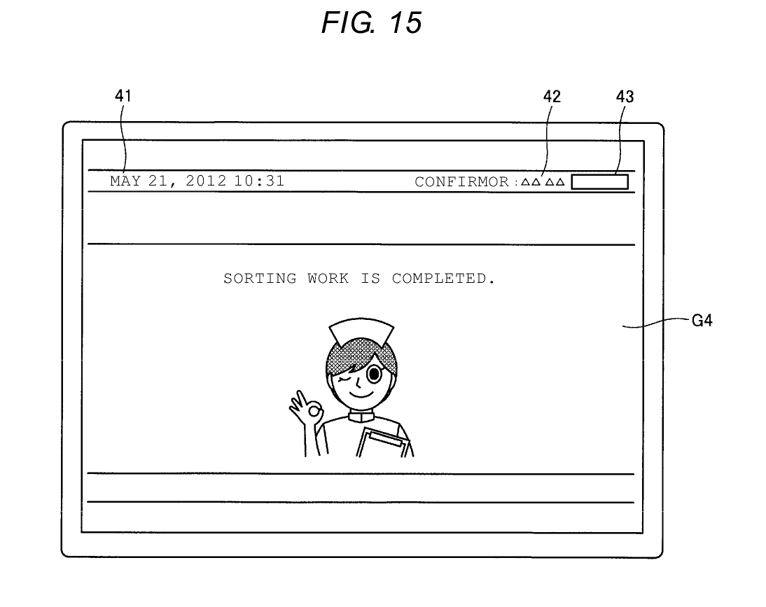

FIG. 15 is a diagram illustrating an example of an inspection completion screen.

A message “The sorting work has been completed” is displayed on an inspection completion screen G4, and thus, the operator can easily detect that the sorting work of the candidate drugs and the inspection process have been correctly completed.

On the other hand, in the determination of step S47, if the sorting of all the drugs is not completed yet (No in step S47), the MPU 31 determines whether the drug inspection result of a candidate drug that is a target of a current drug inspection process is normal (step S18).

In the determination of step S18, if the drug inspection result is normal (Yes in step S18), a screen display process when the inspection result is normal is performed (step S19). Then, the procedure proceeds to step S15 again, to reflect the inspection result display screen in the order content display screen display.

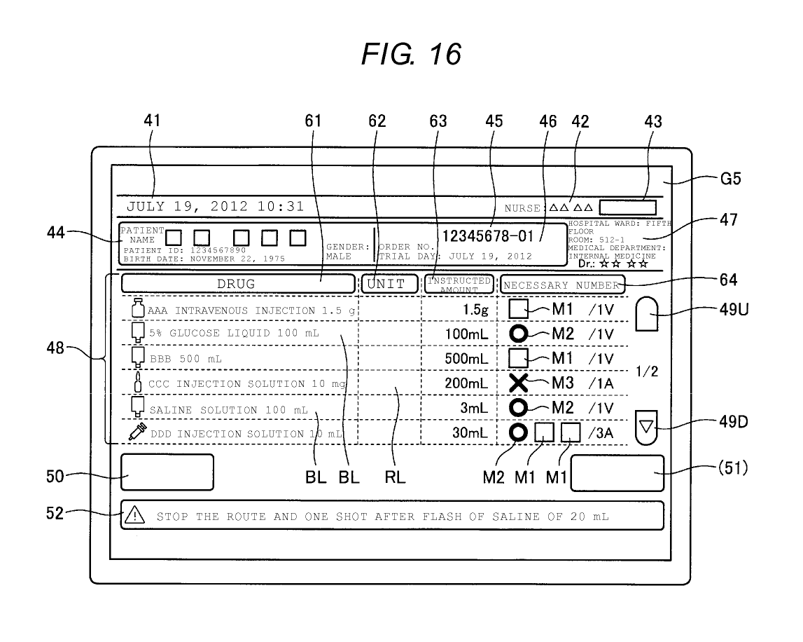

FIG. 16 is a diagram illustrating an example of a display screen of an inspection result.

In the case of an example of an inspection result display screen G5 in FIG. 16, for example, if the read drug code indicates a drug name “5% glucose liquid of 100 mL”, a mark M2 represents that one bag is sorted (“mark O” in FIG. 16) at a time point shown in FIG. 7, instead of one mark M1 that represents that it is necessary to include one bag in total, is displayed in the instructed amount display area 63 of a section of a drug name “5% glucose liquid of 100 mL” that is present in the second row from the top of the list. Further, for example, the section of the drug name “5% glucose liquid of 100 mL” is changed into a blue line display BL that represents that the drug corresponding to the corresponding section is satisfactorily inspected.

Further, if the read drug code corresponds to a drug name “DDD injection solution of 10 mL”, a mark M2 that represents that one ampoule bottle bag is sorted (“mark O” in FIG. 16) at a time point shown in FIG. 7, instead of the leading mark M1 among three marks M1 that represent that it is necessary to include three ampoule bottles in total, is displayed in the instructed amount display area 63 of a section of a drug name “DDD injection solution of 10 mL” that is present in the sixth row from the top of the list. In this case, since the necessary number of the drug is not sorted, at this point, the color of the section of the drug name “DDD injection solution” is not changed (e.g., not displayed using a blue line display BL) compared with the case of FIG. 7.

As described above, if the necessary number of the drug among the drugs displayed in the drug list is sorted, since the section enters a state indicating the fact (in this example, blue line display BL), the operator may easily determine whether inspection is completed for each drug.

Further, in the instructed amount display area 63, since only the marks of which the total number is already inspected is changed into different marks for display compared with the case before the inspected, the operator may easily recognize how many more units remain to be inspected.

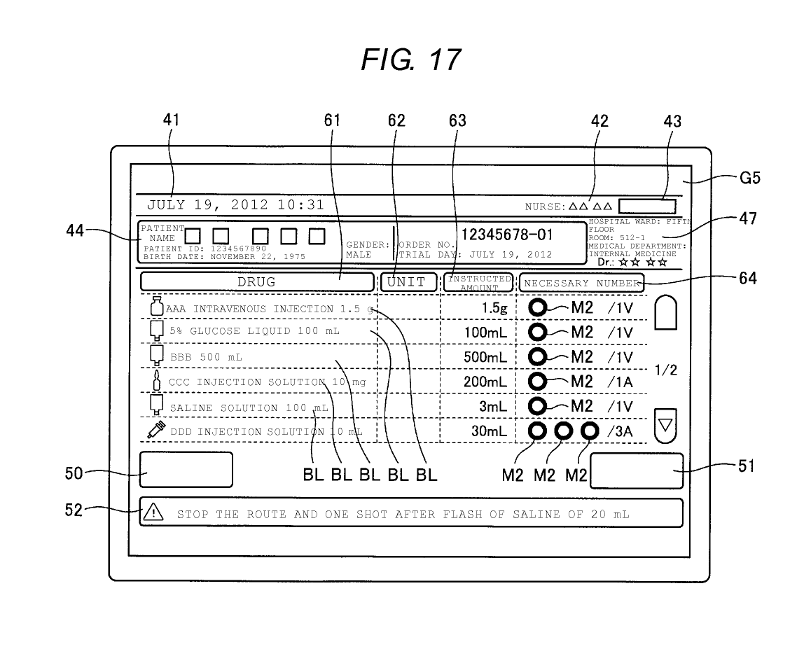

FIG. 17 is a diagram illustrating an example of an inspection result display screen when all the drugs are inspected.

As shown in FIG. 17, if all the inspection processes are normal and all the drugs are included, the marks M2 that represent that the drugs are included (in FIG. 17, mark “O”), that were the marks M1 at the time point shown in FIG. 7, are displayed in the instructed amount display area 63 corresponding to all the drugs. Further, all the drug sections are changed into the blue line displays BL that indicate all the drugs corresponding to the sections are satisfactorily inspected.

If the screen display when the inspection result is normal is completed, the MPU 31 causes the procedure to proceed to step S15 again. In a state where the order content display screen G3 is displayed at that time, in order to perform the inspection process of the drug of the mixed injection target, an operator causes the scanner 37 to read an GS1 data bar (GS1-RSS code: medical drug bar code) indicated on a container or a cover of the candidate drug for inclusion in the mixed injection (step S16), and repeats the same processes.

On the other hand, in the determination of step S18, if the drug inspection result is abnormal (No in step S18), the MPU 31 determines whether the determination reason for the abnormal drug inspection result is expiration (step S20).

In the determination of step S20, if the determination reason for the abnormal drug inspection result is expiration (Yes in step S20), the MPU 31 performs an expiration notification screen display process (step S21).

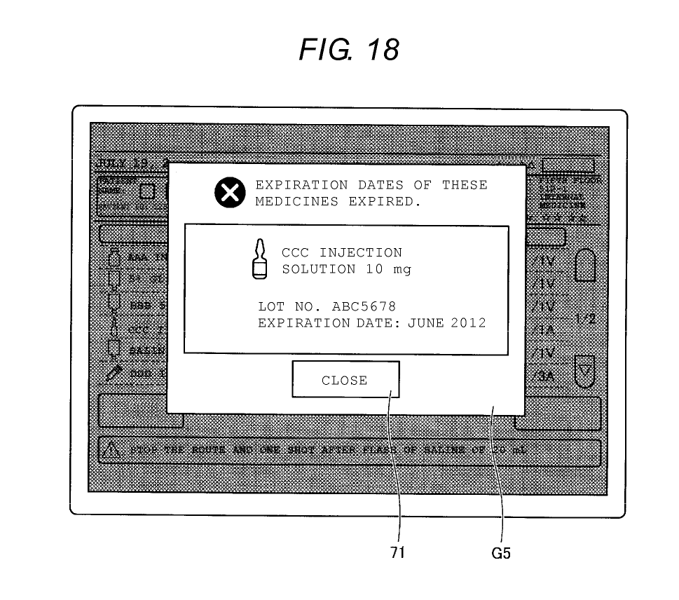

FIG. 18 is a diagram illustrating an expiration notification screen.

On an expiration notification screen G5, if there is a message “Expiration date of the medicine expires”, and for example, a drug name of the expired drug is “CCC injection solution of 10 mg”, the drug name “CCC injection solution of 10 mg”, and its lot number and expiration date are displayed.

Then, if the operator confirms the content and taps the “close” button 71 displayed on the expiration notification screen G5, the procedure proceeds to step S25.

Further, in the determination of step S20, if the reason for the abnormal drug inspection result is not the expiration (No in step S20), the MPU 31 determines whether the reason for the abnormal drug inspection result is an excessive amount (the amount of the drug exceeds the necessary amount) (step S22).

In the determination of step S22, if the reason for the abnormal drug inspection result is an excessive amount (Yes in step S22), the MPU 31 performs an excessive amount notification screen display process (step S23).

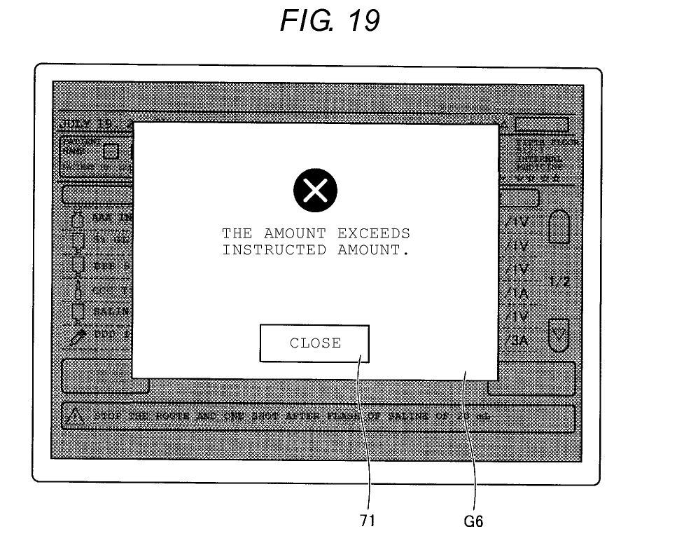

FIG. 19 is a diagram illustrating an example of an excessive amount notification screen.

A message “The amount exceeds the instructed amount” is displayed on an excessive amount notification screen G6.

Further, if the operator confirms the content and taps the “close” button 71 displayed on the excessive amount notification screen G6, the procedure proceeds to step S25.

Further, in the determination of step S22, if the reason for the abnormal drug inspection result is not the excessive amount (No in step S22), the MPU 31 determines that the reason for the abnormal drug inspection result is a mistaken drug preparation in which a drug code of a drug that is not instructed (prescribed) is mistakenly read, and performs a mistaken drug preparation notification screen display process (step S24).

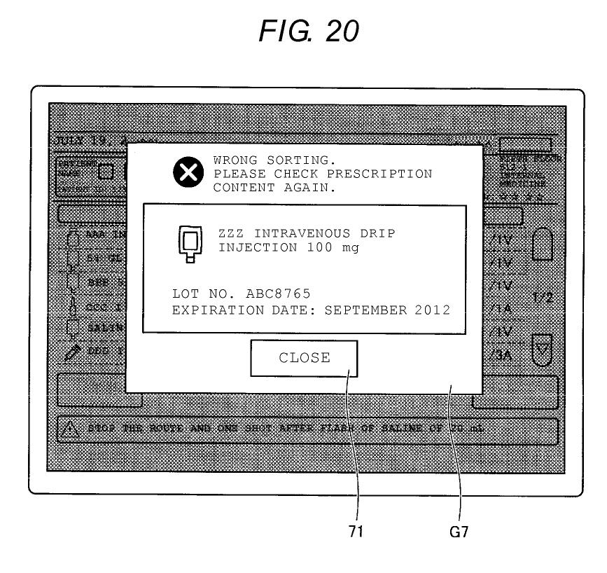

FIG. 20 is a diagram illustrating an example of a mistaken drug preparation notification screen.

On a mistaken drug preparation notification screen G7, if there is a message “Wrong sorting. Please check prescription content again”, and for example, a drug name of the drug that is mistakenly sorted is “ZZZ intravenous drip injection of 100 mg”, the drug name “ZZZ intravenous drip injection of 100 mg”, and its lot number and expiration date are displayed.

If the operator confirms the content and taps the “close” button 71 displayed on the mistaken drug preparation notification screen G7, the MPU 31 performs the screen display process when the inspection result is abnormal (step S25), and cause the procedure to proceed to step S15 again to reflect the display screen of the inspection result on the order content display screen display.

Here, the description will be made again referring to the display screen of the inspection result in FIG. 16.

In the case of the example of the display screen G5 of the inspection result in FIG. 16, for example, if the read drug code is a drug name “CCC injection solution of 10 mg” and the expiration date thereof expires, a mark M3 that represents that the inspection is abnormal, that is, there is the same drug of which the expiration date expires (“mark X” in FIG. 16) at the time point shown in FIG. 7, instead of one mark M1 that represents that it is necessary to include one ampoule bottle in total, is displayed in the instructed amount display area 63 of a section of a drug name “CCC injection solution of 10 mg” that is present in the fourth row from the top of the list. Further, for example, the section of the drug name “CCC injection solution of 10 mg” is changed into a red line display RL that represents that the drug corresponding to the corresponding section is abnormal in inspection.

As described above, if there is an abnormal inspection among the drugs displayed in the drug list, since the corresponding section enters a state indicating the abnormal inspection (in this case, the red line display RL), the operator may easily detect the abnormal inspection.

Further, in the instructed amount display area 63, since only the marks of which the total number already sorted is changed into different marks for display compared with the case before the sorting, the operator may easily recognize how many more units should be included.

Further, in this case, the abnormal inspection reason may be linked to the mark M3 to tap the mark M3, so that display of the corresponding reason (display corresponding to one of the displays in FIGS. 18 to 20) may be performed.

In the determination of step S14, if the response of the electronic medical report server 11 or the pharmacy server 19 is not the transmission of the list data on the drugs of the mixed injection targets corresponding to the order number, this means that there is an error in the order content (Yes in step S14), and thus, the MPU 31 determines whether the content of the error is an error that represents that the drug sorting related to the order number has already been executed (step S26).

In the determination of step S26, if the error content represents that the drug sorting is already executed (Yes in step S26), the MPU 31 performs an execution information confirming instruction screen display process (step S27).

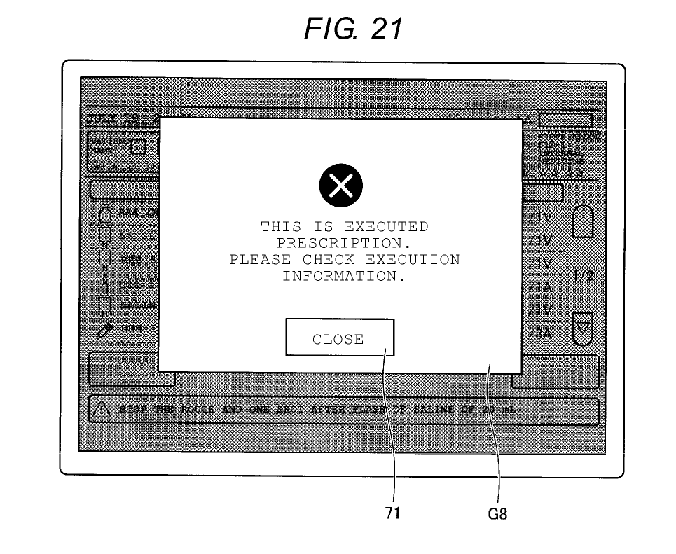

FIG. 21 is a diagram illustrating an example of an execution information confirming instruction screen.

On an execution information confirming instruction screen G8, a message “Executed prescription. Please check execution information.” is displayed.

Then, if the operator checks the content and taps the “close” button 71 displayed on the execution information confirming instruction screen G8, the procedure proceeds to step S11. Then, the login screen G1 is displayed, and thereafter, the same processes are performed.

In the determination of step S26, if the error content represents that drug sorting has not already been executed (No in step S26), the MPU 31 determines whether the error content is an error indicating there has been a change in content of the prescription, that is, content of the order (step S28).

In the determination of step S28, if the error content represents that there has been a change in the order content (Yes in step S28), the MPU 31 performs a medical record confirming instruction screen display process (step S29).

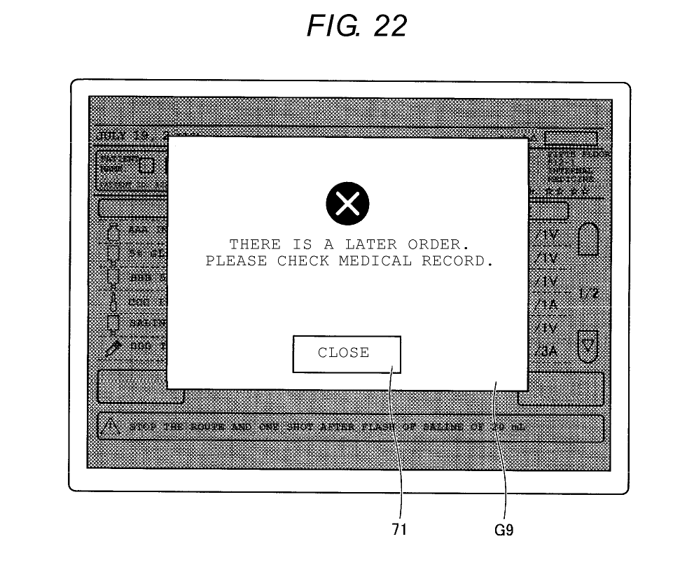

FIG. 22 is a diagram illustrating an example of a medical record confirming instruction screen.

On a medical record confirming instruction screen G9, a message “This is the latest order. Please check medical record.” is displayed.

Then, if the operator checks the content and then taps the “close” button 71 displayed on the medical record confirming instruction screen G9, the procedure proceeds to step S11. Then, the login screen G1 is displayed, and thereafter, the same processes are performed.

In the determination of step S28, if the error content represents that there has been no change in the order content (No in step S28), the error is an error of re-sorting after the drug sorting, and thus, the MPU 31 performs a re-sorting confirmation screen display process (step S30).

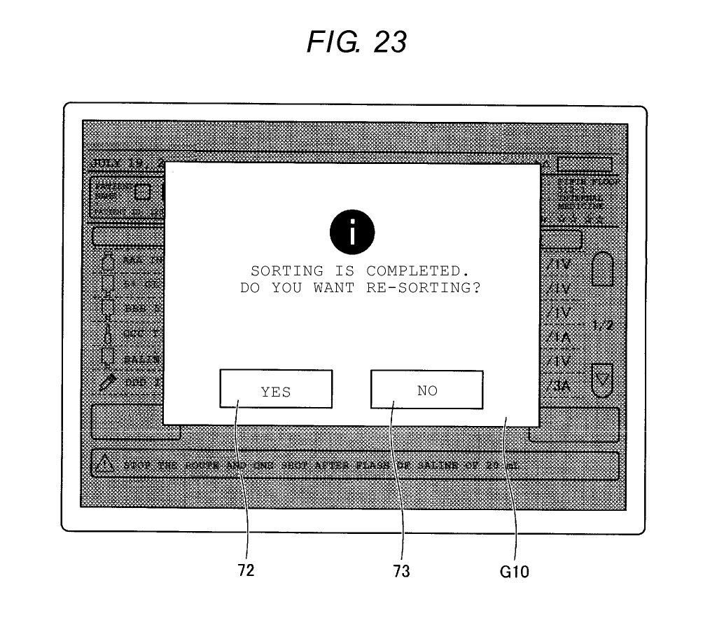

FIG. 23 is a diagram illustrating an example of a re-sorting confirmation screen.

On a re-sorting confirmation screen G10, a message “Sorting is completed. Do you want re-sorting?” is displayed.

Further, on the re-sorting confirmation screen G10, a “Yes” button 72 tapped when the operator wants re-sorting and a “No” button 73 tapped when the operator does not want re-sorting are displayed.

Accordingly, the MPU 31 determines whether either the “Yes” button 72 or the “No” button 73 is tapped, that is, whether the operator wants re-sorting (step S31).

In the determination of step S31, if the operator taps the “No” button 73, that is, the operator does not want re-sorting (No in step S31), the procedure proceeds to step S11. Then, the same processes are repeatedly performed.

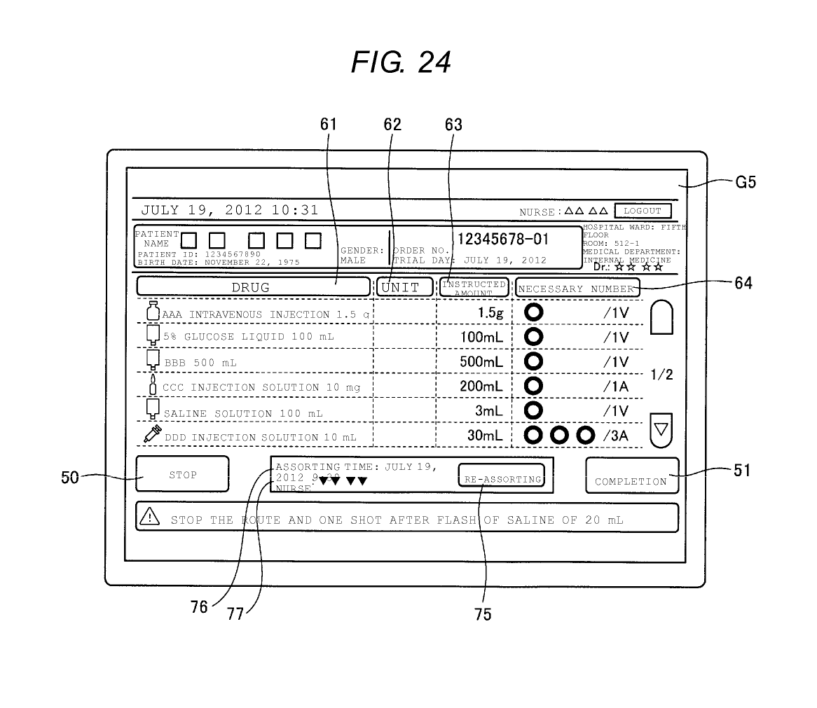

FIG. 24 is a diagram illustrating a display example of an order content display screen when re-sorting is desired.

In the determination of step S31, if the operator taps the “Yes” button 72, that is, the operator wants re-sorting (Yes in step S31), a re-sorting execution screen display process for displaying an order content display screen that is a re-sorting execution screen is performed (step S32), and the order content display screen G3 is displayed (step S15).

Here, when the order content display screen G5 in FIG. 24 is displayed, since the drug inspection process has already been completed once, a re-sorting button 75 is displayed in addition to the display screen of the inspection result when all the drugs shown in FIG. 11 are sorted. Further, the previous sorting time is displayed in a previous sorting time display area 76, and a name of a responsible person for the previous sorting (a name of a responsible person in the previous drug inspection) is displayed in a previous responsible person name display area 77.

Accordingly, as the operator taps the re-sorting button 75, the order content display screen G5 is displayed again in the initial state shown in FIG. 7, and thereafter, the same drug inspection process is performed.

Next, a button tapping process that is performed in association with the above process will be described.

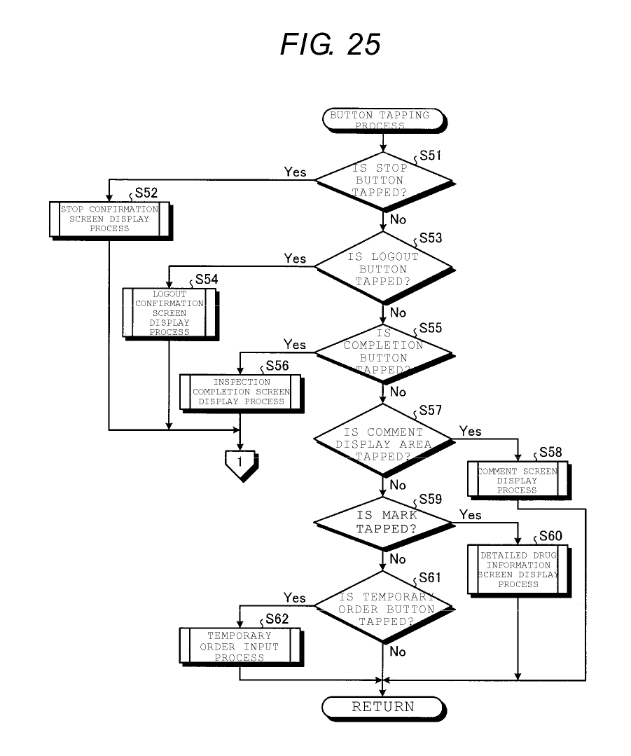

FIG. 25 is a flowchart of a button tapping process performed as an interruption process.

In this embodiment, the MPU 31 inspects (monitors) button tapping at all times. If the button tapping is performed, first, the MPU 31 determines whether the stop button 50 shown in FIG. 7 is tapped (step S51).

In the determination of step S51, if the stop button 50 is tapped (Yes in step S51), the MPU 31 performs a stop confirmation screen display process (step S52).

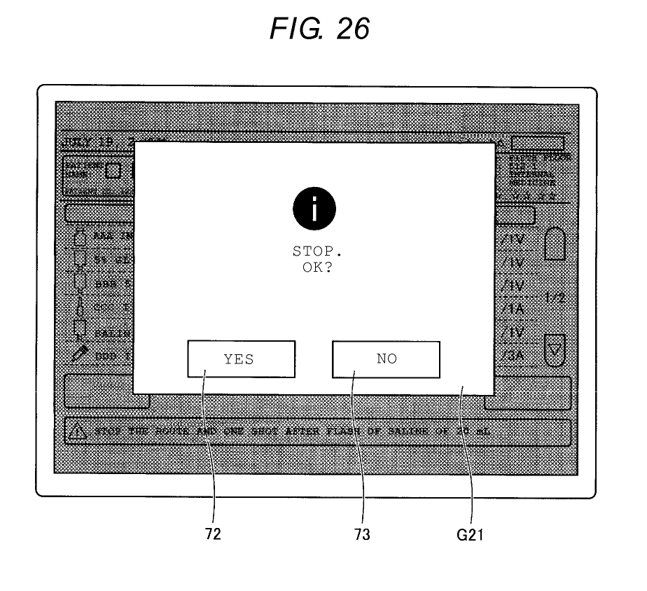

FIG. 26 is a diagram illustrating an example of a stop confirmation screen.

On a stop confirmation screen G21, a message “Stop. OK?” is displayed.

Further, on the stop confirmation screen G21, a “Yes” button 72 tapped when the operator wants to stop the drug inspection process and a “No” button 73 tapped when the operator does not want re-sorting are displayed.

Accordingly, if the “Yes” button 72 is tapped, that is, if the operator wants to stop the drug inspection process, the procedure proceeds to step S11, and the MPU 31 displays the login screen G1 again to enter a standby state.

On the other hand, if the “No” button 73 is tapped, the MPU 31 returns to the display screen in which the stop button 50 is tapped, and then continues the subsequent processes.

In the determination of step S51, if the stop button 50 is not tapped (No in step S51), the MPU 31 determines whether the logout button 43 shown in FIG. 7 is tapped (step S53).

In the determination of step S53, if the logout button 43 is tapped (Yes in step S53), the MPU 31 performs a logout confirmation screen display process (step S54).

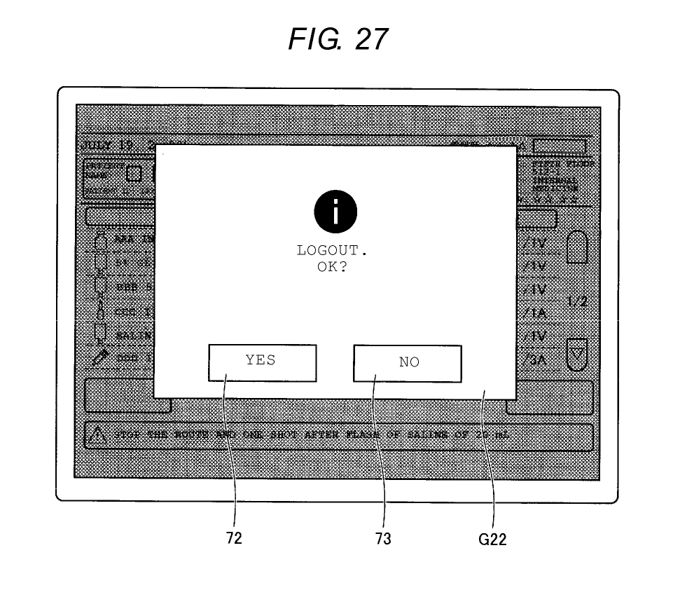

FIG. 27 is a diagram illustrating an example of a logout confirmation screen.

On a logout confirmation screen G22, a message “Logout. OK?” is displayed.

Further, on the logout confirmation screen G22, a “Yes” button 72 tapped when the operator wants logout and a “No” button 73 tapped when the operator does not want logout are displayed.

Accordingly, if the “Yes” button 72 is tapped, that is, if the operator wants logout, the procedure proceeds to step S11, and the MPU 31 displays the login screen G1 again to enter a standby state.

On the other hand, if the “No” button 73 is tapped, the MPU 31 returns to the display screen in which the logout button 43 is tapped, and then continues the subsequent processes.

In the determination of step S53, if the logout button 43 is not tapped (No in step S53), the MPU 31 determines whether the completion button 51 shown in FIG. 11 is tapped (step S55).

In the determination of step S55, if the completion button 51 is tapped (Yes in step S55), the MPU 31 performs an inspection completion screen display process in which the inspection completion screen G4 shown in FIG. 9 is displayed (step S56). Then, the procedure proceeds to step S11, and then, the MPU 31 displays the login screen G1 again to enter a standby state.

In the determination of step S55, if the completion button 51 is not tapped (No in step S55), the MPU 31 determines whether the comment display area 52 shown in FIG. 7 is tapped (step S57).

In the determination of step S57, if the comment display area 52 shown in FIG. 7 is tapped, the MPU 31 performs a comment screen display process (step S58).

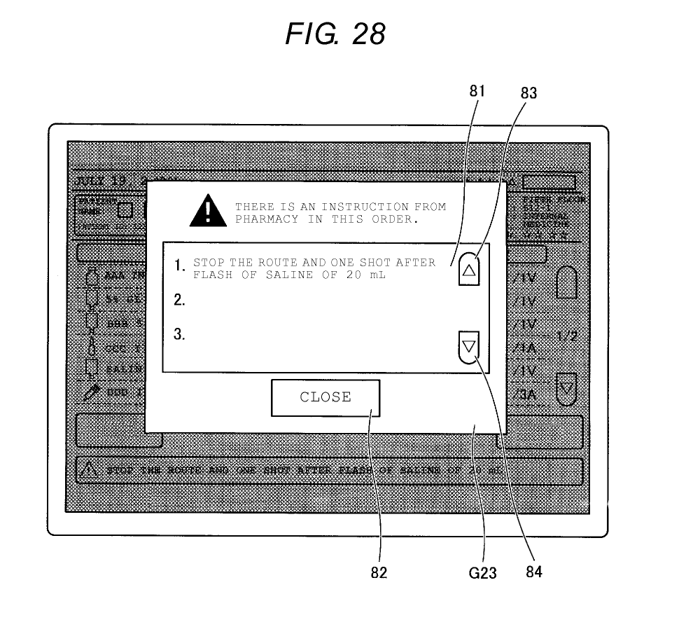

FIG. 28 is a diagram illustrating an example of a comment screen.

A comment screen G23 is a screen on which an instruction comment from a pharmacy in a corresponding prescription is displayed.

On the comment screen G23, a message “There is an instruction from the pharmacy in this order” is displayed.

Further, a comment display 81 that displays the instruction from the pharmacy, a “close” button 82 for closing the comment screen G23, an up-scroll button 83 for scrolling the comment upward, and a down-scroll button 84 for scrolling the comment downward are displayed on the comment screen G23.

Accordingly, if the up-scroll button 83 or the down-scroll button 84 is tapped, the MPU 31 enables the comment to be scrolled upward or downward in the comment display 81.

Further, if the “close” button 82 is tapped, the MPU 31 returns to the display screen in which the comment display area 52 is tapped, and then continues the subsequent processes.

In the determination of step S57, if the comment display area 52 is not tapped (No in step S57), the MPU 31 determines whether the mark M2 corresponding to the drug of which the drug inspection shown in FIG. 10 is normally terminated is tapped (step S59).

In the determination of step S59, if the mark M2 corresponding to the drug of which the drug inspection shown in FIG. 10 is normally terminated is tapped (Yes in step S59), the MPU 31 performs a detailed drug information screen display process of displaying detailed information about the drug corresponding to the mark M2 (step S60).

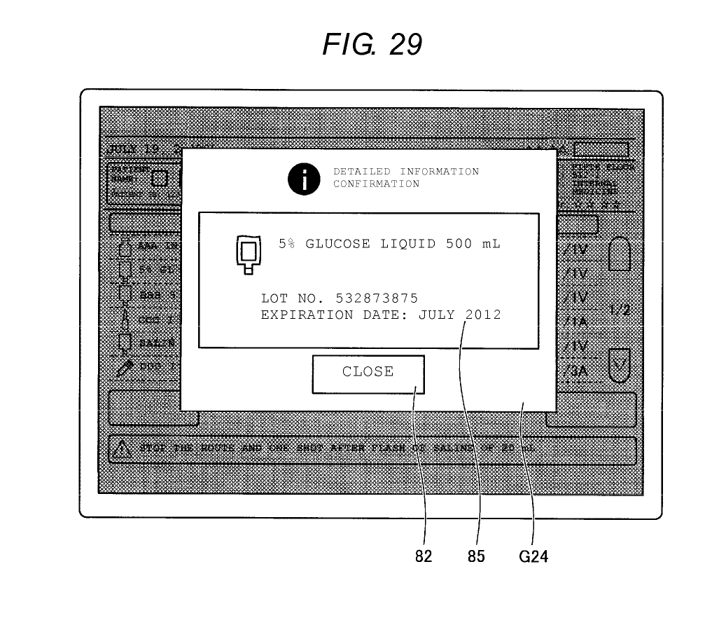

FIG. 29 is a diagram illustrating an example of a detailed drug information confirmation screen.

On a detailed drug information confirmation screen G24, a message “Detailed information confirmation” is displayed.

Further, on the detailed drug information confirmation screen G24, a detailed information display unit 85 that displays a drug name (in the case of an example in FIG. 29, “5% glucose liquid of 500 mL”), its lot number and expiration date as detailed information of the drug corresponding to the mark M2, and a “close” button 82 for closing the detailed drug information confirmation screen G24 are displayed.

Accordingly, if the “close” button 82 is tapped, the MPU 31 returns to the display screen in which the mark M2 is tapped, and then continues the subsequent processes.

In the determination of step S59, if the mark M2 corresponding to the drug of which the drug inspection is normally terminated is not tapped (No in step S59), the MPU 31 determines whether the temporary order button B1 shown in FIG. 6 is tapped (step S61).

In the determination of step S61, if the temporary order button B1 shown in FIG. 6 is tapped (Yes in step S61), the MPU 31 performs a temporary order input process (step S62).

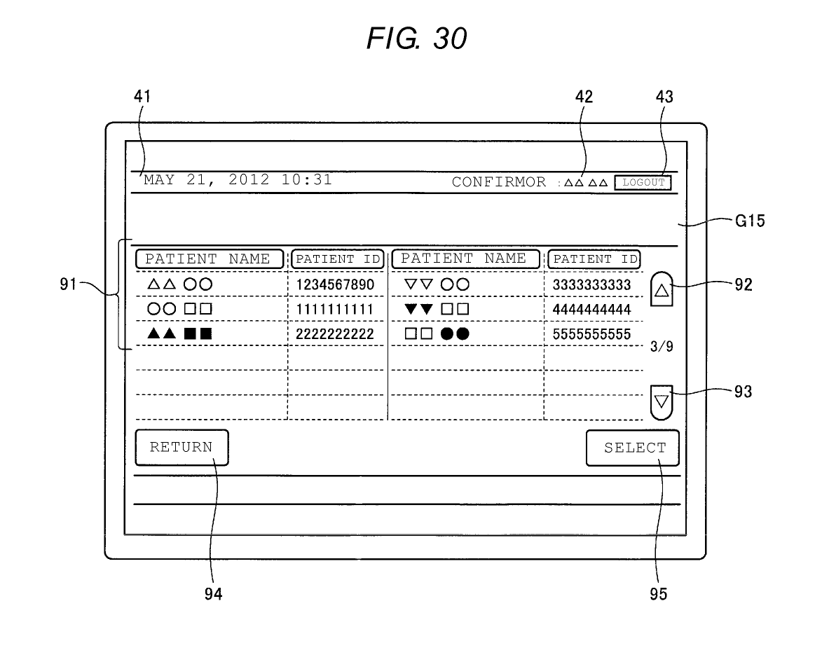

FIG. 30 is a diagram illustrating an example of an initial screen of the temporary order input process.

On an initial screen G15 of the temporary order input process, a message “Please select the patient.” is displayed.

Further, on the initial screen G15 of the temporary order input process, a patient list display selection area 91 in which a list of patient names that are input targets of a temporary order is displayed in a patient selectable manner, an up-scroll button 92 for scrolling the patient list upward in the patient list display selection area 91, a down-scroll button 93 for scrolling the patient list downward in the patient list display selection area 91, a button 94 for returning to the order number input screen G2 shown in FIG. 6, and a select button 95 for selecting any patient selected in the patient list display selection area 91 are displayed.

Accordingly, if selection of any patient is made by the select button 95, the MPU 31 proceeds to the temporary order input process with respect to the corresponding patient.

As described above, according to the present exemplary embodiment, it is possible to easily make an inquiry to a doctor or the like who sets the content about the content of the drug instruction list used in the mixing preparation.

In the above description, when the transmission process for performing communication (e.g., telephone call and data communication) with the mobile information processing terminal 18 through the communication network 17, the public communication network 16 such as a telephone line network and the wireless base station 15 is performed, the doctor makes a response using the mobile information processing terminal 18. In this regard, in a situation where the doctor cannot make a response (or does not make a response), the inquiry process may enter a hold state.

Further, if the inquiry process in the hold state is present, in order to notify the presence of the inquiry in the hold state to the operator, an indication that the hold process is present may be displayed on the display screen of the display.

With such a configuration, the operator may easily detect that the inquiry is being processed even when other processes are performed, and thus, the process is not suspended.

In the above description, a case where the electronic medical record that includes the drug instruction data (for example, prescription data) is stored in the electronic medical record server 11 is described, but a configuration may be used in which the instruction data is managed by the pharmacy server 19, or a configuration may be used in which a separate management server that manages the prescription data is provided.

In the above description, the electronic medical record server 11 and the pharmacy server 19 are provided as independent information processing apparatuses, but may be provided as a cloud system that includes plural information processing apparatuses.

In the above description, although the mobile information processing terminal 18 for doctor has not been described in detail, the mobile information processing terminal 18 may be connected to the communication network 17 through the wireless base station 15 and the public communication network 16 to then be connected to the electronic medical record server 11 or the pharmacy server 19, to thereby edit the electronic medical record.

In the above description, the scanner 37 for scanning and specifying a nurse ID, and a drug bar code (identification code), a drug image or the like in order to specify a nurse that is a user and a drug that is a mixed injection candidate is provided, but when an RFID for identification is used, an RFID reader (or RFID reader-writer) that reads an identification code included in an RFID tag may be provided instead of the scanner 37. In this case, a configuration may be used in which RFID tags of plural drugs are read in a lump, that is simultaneously or in rapid succession. Further, if identification information (identification code) is matched with the nurse ID and the drug, a reader (or reader-writer) that reads the identification information may be provided.

Further, an identification code such as an identification code included in the bar code or the RFID tag as described above may be used for disposal management of drugs including blood for transfusion or the like.

Further, in the above description, although the role of the scale 25 is not described in detail, a method of using the scale 25 for prevention of preparation errors will be here described.

The MPU 31 measures weights of each drug in a state where the drug is specified before and after an actual mixed injection work, using the scale 25. Further, the MPU 31 records a weight difference based on before and after the mixed injection preparation in the external storage unit 34 in correspondence with the drug.

This is because when the drug is accommodated in a vial, and for example, when a mixed injection preparation corresponding to one instruction is performed, the drug may not be entirely used and a part of the drug may be used in the mixed injection preparation by an injector or the like (e.g., a syringe flush or the like). Consequently, if the weight difference before and after the use of the drug is calculated, it is possible to detect the amount of the drug used in the actual mixed injection.

Further, the MPU 31 compares the amount of the drug used in the actual mixed injection with the instructed amount shown in the instruction data (the amount displayed in the instructed amount display area 63), and if the difference is within an allowable difference range, the MPU 31 determines that the mixed injection preparation is correctly performed. In this case, if the instructed amount is designated as a capacity (e.g., volume), the weight difference is converted into the capacity by the MPU 31.

On the other hand, if the difference between the amount of the drug used in the actual mixed injection and the instructed amount shown in the instruction data exceeds the allowable difference, the MPU 31 notifies that the mixed injection work is not correctly performed.

Consequently, the mixed injection terminal 14 inspects the mixed injection work, to thereby make it possible to prevent the prescription from being administered to a patient in a preparation error state.

According to embodiment, there may be provided a drug mixing preparation managing apparatus that is connectable to an information processing terminal (mobile information processing apparatus, fixed information processing apparatus, computer, smart phone, tablet or the like) used by a doctor who has an approval authority through a communication network and performs an inspection process of a drug used in mixing preparation according to a predetermined instructed drug list, including: an inquiry unit that makes an inquiry to the information processing terminal about whether approval of change in content of the instructed drug list is possible; and an inspection processing unit that performs, when the approval of the change in the content of the instructed drug list with respect to the inquiry is notified, an inspection process of a drug used in mixing preparation according to an instructed drug list after the change.

According to yet another embodiment, there may be provided a drug mixing preparation managing system including: an information processing terminal used by a doctor who has an approval authority; and a drug mixing preparation managing apparatus that is connectable to the information processing terminal through a communication network and performs an inspection process of a drug used in mixing preparation according to a predetermined instructed drug list, in which the drug mixing preparation managing system may include an inquiry unit that notifies an instructed drug list before change and an instructed drug list after the change to the information processing terminal and makes an inquiry to the information processing terminal about whether approval of change in content of the instructed drug list is possible, and an inspection processing unit that performs, when the approval of the change in the content of the instructed drug list with respect to the inquiry is notified, an inspection process of a drug used in mixing preparation according to the instructed drug list after the change, and in which the information processing terminal may include a display control unit that receives the inquiry, displays the instructed drug list before the change on a display unit and the instructed drug list after the change and displays a screen that prompts an input about whether the approval is possible on the display unit, an input unit through which the input about whether the approval is possible is performed, and a notification unit that notifies whether the approval of the change in the content of the instructed drug list is possible according to the input in the input unit.

In addition, there may be provided a control program for controlling, a drug mixing preparation managing apparatus that is connectable to an information processing terminal used by a doctor who has an approval authority through a communication network and performs an inspection process of a drug used in mixing preparation according to a predetermined instructed drug list and causing the computer to function as units including: an inquiry unit configured to make an inquiry to the information processing terminal about whether approval of change in content of the instructed drug list is possible; and an inspection processing unit configured to perform, when the approval of the change in the content of the instructed drug list with respect to the inquiry is notified, an inspection process of a drug used in mixing preparation according to an instructed drug list after the change.

The control program may be recorded for provision on a computer-readable recording medium such as a CD-ROM, a flexible disk (FD), a CD-R or a digital versatile disk (DVD) as a file of an installable format or an executable format.

Further, the control program executed in the drug mixing preparation managing apparatus of the present exemplary embodiment may be stored in a computer connected to a network such as the Internet and may be downloaded through the network for provision. Further, the control program executed in the drug mixing preparation managing apparatus of the present exemplary embodiment may be provided or distributed through the network such as the Internet.

Further, the control program of the drug mixing preparation managing apparatus of the present exemplary embodiment may be provided by being installed in a ROM or the like of drug mixing preparation managing apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method for managing a drug mixing preparation process, comprising:
obtaining a mixed injection preparation instruction;
displaying a screen for an operator to enter a change to the mixed injection preparation instruction;
receiving the change to the mixed injection preparation instruction entered by the operator;
connecting to an information processing terminal through a network;
requesting a user of the information processing terminal approve the change in the mixed injection preparation instruction; and
if the change in the mixed injection preparation instruction is approved by the user, managing a mixed injection preparation process in accordance with the changed mixed injection preparation instruction.

2. The method of claim 1, wherein the user is a doctor.

3. The method of claim 1, wherein the information processing terminal is a smart phone.

4. The method of claim 1, wherein the step of requesting a user of the information processing terminal approve the change in the mixed injection preparation instruction includes making a telephone call to the user.

5. The method of claim 4, further comprising recording the telephone call.

6. The method of claim 1, wherein the network comprises a public communications network.

7. The method claim 1, further comprising simultaneously displaying content of an obtained mixed injection preparation instruction on a same screen as content of a changed mixed injection preparation instruction.

8. The method of claim 1, wherein the mixed injection preparation process includes:
obtaining a list of drugs to be included in a mixed injection according to a changed mixed injection preparation instruction;
obtaining information about a candidate drug for inclusion in the mixed injection;
comparing obtained information about the candidate drug to the changed mixed injection preparation instruction; and
determining whether the mixed injection is prepared in accordance with the changed mixed injection preparation instruction based on a comparison of obtained information about the candidate drug to the change mixed injection preparation instruction.

9. The method of claim 8, wherein the list of drugs is displayed on the information processing terminal with an illustration of each drug on the list of drugs.

10. The method of claim 8, wherein obtaining information about the candidate drug comprises reading a radio frequency identification (RFID) tag associated with the candidate drug.

11. The method of claim 8, wherein obtaining information about the candidate drug comprises using a bar code reader to read a bar code associated with the candidate drug.

12. The method of claim 11, wherein the bar code is a medical drug bar code.

13. The method of claim 1, further comprising:
causing a change approval screen to be displayed on the information processing terminal.

14. A drug mixing preparation managing apparatus, comprising:
a communication interface configured to receive a mixed injection preparation instruction and to connect to an information processing terminal through a network;
a display module configured to display content of the mixed injection preparation instruction and to display a change screen for an operator to enter a change to the mixed injection preparation instruction;
an inquiry module configured to send an inquiry through the network to the information processing terminal regarding whether a user of the information processing terminal approves the change to the mixed injection preparation instruction; and
an inspection processing module configured to manage a mixed injection preparation process in accordance with a changed mixed injection preparation instruction when the user approves the change to the mixed injection preparation instruction.

15. The apparatus of claim 14, wherein the communication interface connects to the information processing terminal through a network comprising a public communication network.

16. The apparatus of claim 14, wherein the display module includes a touch screen display panel.

17. The apparatus of claim 14, further comprising:
a scanner configured to read a bar code on a candidate drug container; and
a camera configured to acquire images of the operator during the mixed injection preparation process.

18. The apparatus of claim 17, wherein the scanner is a fixed-type scanner.

19. The apparatus of claim 17, wherein the scanner is a hand-type scanner.

20. The apparatus of claim 17, further comprising a scale for measuring a weight of the candidate drug.

21. A non-transitory computer readable medium storing a computer program for controlling an apparatus to carry out a method for managing a drug mixing preparation, said method comprising the steps of:
obtaining a mixed injection preparation instruction;
displaying a screen for an operator to enter a change to the mixed injection preparation instruction;
receiving the change to the mixed injection preparation instruction from the operator;
connecting to an information processing terminal through a network;
requesting a user of the information processing terminal approve the change in the mixed injection preparation instruction; and
if the change in the mixed injection preparation instruction is approved by the user, managing a mixed injection preparation process in accordance with the changed mixed injection preparation instruction.

22. The non-transitory computer readable medium of claim 21, wherein the step of requesting a user of the information processing terminal approve the change in the mixed injection preparation instruction includes making a telephone call to the user.

23. The non-transitory computer readable medium of claim 21, the steps of the method further comprising simultaneously displaying content of an obtained mixed injection preparation instruction on a same screen as content of a changed mixed injection preparation instruction.
